(19) United States
(12) Patent Application Publication
(10) Pub. No.: US 2024/0199894 A1
(43) Pub. Date: Jun. 20, 2024

(54) Heat Resistant Coating Composition

(71) Applicant: Akzo Nobel Coatings International B.V., Amsterdam (NL)

(72) Inventors: Stephen FRANK, Amsterdam (NL); Ian Paul JOHNSON, Amsterdam (NL); Dusan NOVAK, Amsterdam (NL)

(21) Appl. No.: 18/286,645

(22) PCT Filed: Apr. 19, 2022
(86) PCT No.: PCT/EP2022/060285

§ 371 Date: Oct. 12, 2023

(30) Foreign Application Priority Data
Apr. 20, 2021 (EP) 21169454.2

(51) Int. Cl. C09D 5/18; C08K 3/32; C08K 5/06; C08K 5/3492; C08K 7/14; C08K 13/02; C09D 7/61; C09D 7/63; C09D 163/00

(52) U.S. Cl. CPC C09D 5/185; C08K 13/02; C09D 7/61; C09D 7/63; C09D 163/00; C08K 2003/323; C08K 5/06; C08K 5/34922; C08K 7/14; C08K 2201/019

(57) ABSTRACT

The invention relates to a heat-resistant coating composition comprising a one or more epoxy resins and one or more poly sulfide curing agents, which also comprises one or more spumifics, one or more carbonifics and one or more sources of phosphoric acid; wherein the mole ratio of thiol groups in the polysulfide(s) to epoxy groups in the epoxy resin(s) is in the range of from 0.20 to 0.50; and wherein the weight ratio of carbonific(s) to spumific(s) is no more than 0.48 or the weight ratio of carbonific(s) to source(s) of phosphoric acid is no more than 0.38, or both.

### TECHNICAL FIELD

The invention relates generally to heat resistant coating compositions, such as intumescent coating compositions.

### BACKGROUND ART

Heat protective coatings are commonly used in buildings and other metallic supporting structures to avoid, or at least delay, structural failure in the event of a fire. They do this by providing an insulating layer which delays heat transfer to the metallic substrate, which increases the time before metal softening and structural failure occurs.

Intumescent coatings are one type of heat protective or heat resistant coating. They can be applied as a relatively thin film, but they swell and harden in the event of a fire to form a thick, insulative layer. They do this by releasing gas when heated, which causes foaming of the coating layer. The foamed coating then chars to form a hardened insulating layer on the substrate.

Intumescent coatings typically comprise a resinous binder which acts as a carbon source for the charring process. Other auxiliary carbon sources can be added if desired. In addition, a spumific is often added, which releases a gas to create the foaming and thickening effect.

Intumescent coatings are distinct from other types of heat protective coatings, such as ablative coatings. Ablative coatings are sacrificial, in that they decompose and/or vapourise in the event of fire thus providing a cooling effect on the coating surface. They are also distinct from fire retardant coatings, whose purpose is to reduce flammability and delay combustion, and which do not have to intumesce. Often, fire retardant coatings comprise high amounts of non-combustible fillers and pigments to prevent the passage of flames, which tend to suppress intumescence.

Examples of intumescent coatings are described in US2015/0284611, US2019/0264080, WO2015/007627 and EP3412736.

WO2012/101042 and WO2014/019947 describe heat resistant compositions comprising epoxy resin and a polysulfide, and which show good performance in two different types of heat resistance tests, namely a pool fire test and a jet fire test.

Pool fire tests simulate exposing the coated substrate to a pool of ignited liquid hydrocarbon. Jet fire tests involve high velocity intense flames, and are used to simulate fires associated with escaped pressurised hydrocarbons, such as those found on a drilling rig, an oil refinery, a chemical plant or a storage depot. It is typically the case that compositions perform well in one of these tests, but not both. Therefore, it would be advantageous to find further compositions which show good all-round performance in both these types of tests.

### SUMMARY OF INVENTION

The present invention is aimed at heat resistant coating compositions having good performance in both jet fire and pool fire tests, and which can also be applied to a surface without the need for a supporting mesh, thus reducing the complexity and duration of the coating application process.

The heat resistant coating composition comprises one or more epoxy resins, one or more polysulfides, one or more spumifics, one or more carbonifics and one or more sources of phosphoric acid.

The mole ratio of thiol groups in the polysulfide(s) to epoxy groups in the epoxy resin(s) is in the range of from 0.20 to 0.50.

The composition also has a weight ratio of carbonific(s) to spumific(s) of no more than 0.48, or alternatively the weight ratio of carbonific(s) to source(s) of phosphoric acid is no more than 0.38. The composition can optionally fulfil both of these requirements.

The invention also relates to a method of applying such a composition to a substrate, to a substrate (e.g. a metallic structure) coated with such a composition, both after application and after curing, and also to the use of such a composition in coating a substrate.

### DESCRIPTION OF EMBODIMENTS

When discussing the concentration or amounts of various components in the compositions, they will be expressed in units of weight percent (wt %) based on the entire composition (e.g. based on the sum of both components in a 2K composition), unless specified otherwise.

Unless specified otherwise, references to aliphatic groups, alkyl groups, haloalkyl groups, alkoxy groups and haloalkoxy groups include linear, branched and cyclic groups, and also groups comprising both cyclic and non-cyclic portions. Aliphatic groups can be saturated or unsaturated, although are typically saturated.

### Epoxy Resin

The heat-resistant coating composition comprises, as a binder component, an epoxy resin. The epoxy resin is curable, i.e. can react with a curing agent to form a polymeric network or matrix. There can be more than one type of resin as binder components, although at least one is an epoxy resin. Optionally, two or more different epoxy resins can be included.

The term “resin” is a widely used term in the field of coating materials, and refers to components that, on their own, can form a polymeric film in the presence of a curing agent. They are often synthetic organic compounds comprising organic molecules that are formed from oligomeric, polymeric or condensation reactions, but which are further polymerisable or cross-linkable to form extended networks. They can also be naturally occurring materials or modified (derivatised) naturally occurring materials.

In the present invention, the epoxy resins in the binder component (in their pre-cured state) can be thermoplastic resins having melting points of 100° C. or less, for example in the range of from −20 to 100° C. If the resin has a melting point range, then the melting point range can fall within the range of −20 to 100° C. Additionally or alternatively, the epoxy resin can have a softening point of 100° C. or less, for example in the range of from −20 to 100° C.

In embodiments, the binder comprises at least one liquid epoxy resin. In this context, “liquid” refers to the state of the epoxy resin at 23° C. and 1 atm (1.013 bar).

Epoxy resins suitable for use include aliphatic epoxy resins, aromatic epoxy resins and epoxy novolac resins, which are typically aromatic epoxy novolac resins.

Aromatic epoxy resins typically include two or more aromatic (or heteroaromatic) groups, for example as found in epoxy substituted diphenylalkyl groups. In embodiments the epoxy resin comprises two or more epoxy groups or epoxy ether groups such as glycidyl or glycidyl ether groups. Examples include bisphenol glycidyl ether resins, bisphenol diglycidyl ether resins, resorcinol glycidyl ether resins and resorcinol diglycidyl ether resins.

Suitable aromatic epoxy resins include those represented by Formula (1):

$$X - Ar - {M}^{1} - Ar - {[ {M}^{2} - Ar ( X ) - {M}^{2} - Ar ]}_{a} - X \qquad ( 1 )$$

Each X independently is selected from alkyl groups, alkoxy groups or alkoxy-substituted alkyl groups. They comprise from 1 to 12 carbon atoms and also an epoxy group. Examples of X include C₁₋₆ epoxy groups, and moieties comprising a C₁-C₆ alkyl group substituted with a C₃-C₆ alkoxy group, where the C₃-C₆ alkoxy group contains an epoxy group. Specific examples include a C₁₋₆ alkyl group substituted with a glycidoxy group, such as a glycidoxypropyl group. In other embodiments, each X is selected from C₁₋₁₂ alkoxy groups comprising an epoxy moiety, for example a C₃₋₆ epoxy-substituted alkoxy group such as a glycidoxy group.

Optionally, each X independently can be substituted with one or more further substituents selected from halide, hydroxy, C₁₋₄ alkoxy and C₁₋₄ haloalkoxy. Where a halide is present (either as a direct substituent or as part of a haloalkoxy group), it is typically selected from F and Cl. In embodiments, no halogen atoms are present, and in further embodiments, there are no further substituents. In embodiments, all X are the same.

Each Ar is independently selected from aromatic and heteroaromatic groups, e.g. groups with a 5 or 6 membered aromatic ring, although typically with 6-membered rings. Heteroatoms in the heteroaromatic group can be selected from one or more O, S and N atoms, for example from 1 to 3 heteroatoms. In embodiments, the aromatic group does not contain a heteroatom.

Each aromatic or heteroaromatic group can optionally be substituted with one or more substituents selected from C₁₋₆ alkyl, C₁₋₆ alkoxy, C₁₋₆ haloalkyl, C₁₋₆ haloalkoxy, halide and hydroxy. Where halogen is present (i.e. as a halide substituent, or as part of a haloalkyl or haloalkoxy group), it is typically selected from F and Cl. In embodiments, no halogen is present. In embodiments, the optional substituent is selected from C₁₋₂ alkyl. In embodiments all Ar are the same.

M¹ is a linking group selected from —[C(R^{a})₂]_{q}— and —SO₂—, where q is from 1 to 3, and each R^{a} is independently selected from H and C₁₋₂ alkyl. In embodiments, M¹ is selected from —CH₂— and —C(Me)₂—.

M² is a hydroxy-substituted C₁₋₁₂ dialkoxy group, e.g. a hydroxy-substituted —O—(CH₂)_{[1-12}]—O— group. In embodiments, M² comprises the same number of carbon atoms as X.

a can be in the range of from 0 to 10, for example from 0 to 5 or from 0 to 2.

In embodiments, the resin can be an epoxy novolac resin, for example those represented by Formula (2)

$$X - Ar - {M}^{3} - {[ Ar ( X ) - {M}^{3} - ]}_{a} - Ar - X \qquad ( 2 )$$

Ar, X and a are as defined above.

M³ is a C₁₋₁₂ aliphatic hydrocarbyl group, e.g. selected from C₁₋₁₂ alkylene groups. Such as methylene (—CH₂—), ethylene (—C₂H₄—), isopropyl (—CH(Me)CH₂—), propyl (—CH₂CH₂CH₂—), and C₅₋₁₀ cyclic aliphatic groups such as cyclohexylene (—C₆H₁₀—) and dicyclopentanyl (—C₁₀H₁₈—). Cyclic groups can optionally comprise one or more C₁₋₃ alkyl substituents. The aliphatic hydrocarbyl group is typically saturated, although in embodiments it can be unsaturated, for example comprising one or more double bonds.

In embodiments, in Formula (2), all occurrences Ar are the same, all M³ are the same and all X are the same.

In embodiments, any of M¹, M² and M³ can optionally be substituted with one or more halides (typically selected from F and Cl), although in further embodiments there are no halide or halide-containing substituents.

Examples of suitable resins include bisphenol (di)glycidyl ether resins and resorcinol (di)glycidyl ether resins, where the bisphenol is bisphenol A, F or S.

In embodiments, bisphenol (di)glycidyl ether resins, such as bisphenol A or F epoxy resins, have epoxy equivalent weights in the range of from 100 to 800 g/eq, for example in the range of from 140 to 550 g/eq.

In embodiments, the resins are so-called epoxy Novolac resins, based on a moiety formed from reaction between an aromatic alcohol (e.g. phenol or cresol) and an aldehyde such as formaldehyde, which can then be modified with an epoxy group, e.g. a glycidyl ether group.

Examples include phenol Novolac epoxy resins, such as DEN™ 425, DEN™ 431 and DEN™ 438 (ex DOW Chemicals), Epon™ 154, Epon™ 160, Epon™ 161 and Epon™ 162 (ex. Momentive Performance Chemicals), and Epalloy™ 8250 (ex. Emerald Chemical Co.). Such epoxy compounds can have an epoxy equivalent weight in the range of 100 to 300, for example 150 to 220 or 165 to 185 g/eq.

Other epoxy resins which may be used include epoxy cresol novolac resins, such as Epon™ 164 and Epon™ 165 (ex. Momentive Performance Chemicals), or bisphenol A epoxy novolac resins, such as the Epon™ SU range of resins.

In embodiments, the epoxy resin has a (number average, Mₙ) molecular weight in the range of from 100 to 3000, for example from 200 to 1500, from 250 to 1000, or from 300 to 800.

The coating composition can comprise more than one epoxy resin, e.g. blends of any of the above epoxy resins may be used in combination with each other. In embodiments, the epoxy resin, or at least one epoxy resin, is a novolac epoxy resin, such as a cresol novolac epoxy resin.

Other epoxy resins include those having at least two epoxy groups attached to aliphatic moieties as opposed to aromatic moieties.

In embodiments, these can be of Formulae (3) and (4)

$$\begin{matrix}{Z}_{4 - b} {C ( OX )}_{b} & ( 3 ) \\ XO - {( {M}^{4} - O )}_{y} - X & ( 4 )\end{matrix}$$

Each M⁴ is independently selected from C₂₋₃₀ aliphatic hydrocarbyl groups, e.g. C₂₋₁₂ aliphatic hydrocarbyl. In embodiments, the aliphatic hydrocarbyl group is a saturated group. Examples include C₁₋₁₂ alkylene groups e.g. methylene (—CH₂—), ethylene (—C₂H₄—), isopropyl (—CH(Me)CH₂—), n-propyl (—CH₂CH₂CH₂—), and C₅₋₁₀ cyclic aliphatic groups such as cyclohexylene (—C₆H₁₀—) and dicyclopentanyl (—C₁₀H₁₈—). Cyclic groups can optionally comprise one or more C₁₋₃ alkyl substituents. M⁴ can optionally be substituted with one or more groups selected from halide (typically selected from F or Cl), —OH, OR¹ (where R¹ is H, C₁₋₄ alkyl or C₁₋₄ haloalkyl) and —OX.

X is as defined above.

b is an integer in the range of from 2 to 4.

y is in the range of from 1 to 10, for example 1 to 5 or from 1 to 3.

Each Z is independently selected from H and C₁₋₂₀ aliphatic hydrocarbyl groups, for example C₁₋₁₂ aliphatic hydrocarbyl groups. In embodiments they are alkyl groups. Optionally, each Z independently can be substituted with one or more further selected from halide, hydroxy, C₁₋₄ alkoxy and C₁₋₄ haloalkoxy. Where a halide is present (either as a direct substituent or as part of a haloalkoxy group), it is typically selected from F and Cl. In embodiments, no halogen atoms are present, and in further embodiments, there are no substituents. In embodiments, all Z groups are the same.

Examples of resins of Formula (3) and (4) include alkyl diglycidyl ethers, e.g. C₁₋₁₆ alkyl diglycidyl ethers, such as glycidyl ethers of di- and polyhydric aliphatic alcohols. Specific examples include hexanediol diglycidyl ether, neopentyl glycol diglycidyl ether, trimethylolpropane triglycidyl ether, glycerol triglycidylether, pentaerythritol tetraglycidyl ether, dipentaerythritol polyglycidyl ethers, butanediol diglycidyl ether, neopentylglycol diglycidyl ether, and sorbitol glycidyl ether.

Further examples include glycidyl ethers of an aliphatic ether or polyether, e.g. dipropyleneglycol diglycidyl ether.

In other embodiments, suitable epoxy resins can be made by epoxidation of unsaturated fats and oils, for example unsaturated fatty acids, diglycerides or triglycerides having C₄₋₃₀ fatty acid or fatty acid ester groups. An example is Cardolite™ NC-513, which is made by reacting epichlorohydrin with an oil obtained from the shells of cashew nuts.

The epoxy resin can also be selected from epoxidized olefins, including dienes, such as C₄₋₃₀, C₆₋₂₈, C₆₋₁₈, C₁₄₋₁₆ or C₆₋₁₂ epoxidised olefins or dienes. They can comprise from 1 to 4 epoxy groups, for example 1 or 2 epoxy groups or 2 to 4 epoxy groups. In embodiments, the epoxy resin comprises 2 epoxy groups. A specific example is diepoxyoctane.

Epoxidised polydienes such as polybutadiene can have a molecular weight (number average, Mₙ) in the range of from 500 to 100000, for example in the range of from 1000 to 50000, or from 2000 to 20000. A specific example includes epoxidized polybutadiene.

In order to minimize the solvent content of any coating composition containing the epoxy resin, it is preferred that the epoxy resin has a low solvent content, e.g., below 20 wt %, or below 10 wt %, based on the weight of epoxy resin. In embodiments, the epoxy resin is free of solvent.

The amount of curable epoxy resin in the coating composition is, in embodiments, in the range of from 5.0 to 55.0 wt %, for example from 10.0 to 45.0 wt %, or from 10.0 to 30.0 wt %.

### Polysulfides

The composition comprises a polysulfide which acts as a curing agent, and forms part of the binder component. Polysulfides are normally medium to high viscous liquids of a light brown colour. They comprise chains (or rings) of sulphur atoms, S_{c} groups, that are linked together by organic groups. In embodiments, c is from 2 to 10, for example from 2 to 5.

The polysulfides comprise thiol groups, which are able to participate in the cross-linking reactions that take place during curing. They can, in embodiments, also comprise other functional moieties, e.g. epoxy groups, although typically the thiol groups are the only reactive functional moieties.

Polysulfides can be obtainable by condensation of alkali polysulfide (e.g. of formula Na₂S_{c}) with compounds such as those of Formula (5):

$$Hal - {M}^{5} - Ha ; \qquad ( 5 )$$

In Formula (5), Hal is a halide, such as Cl or Br.

M⁵ is —([CR^{a}₂]_{d}E-)ₑ[CR₂]_{f} where R^{a} is selected from H, halide (typically selected from F or Cl), —ORD, C₁₋₄ alkyl (e.g. C₁₋₂ alkyl) and C₁₋₄ haloalkyl (e.g. C₁₋₂ haloalkyl), and R^{b} is selected from H, C₁₋₄ alkyl and C₁₋₄ haloalkyl. d is in the range of from 1 to 10 (for example from 1 to 4). E is selected from O and NR^{b}, although where present it is typically O.

e is in the range of from 0 to 20, for example from 0 to 10 or from 0 to 4. f is an integer in the range of from 1 to 20, for example from 2 to 10 or from 2 to 5. In embodiments, M⁵ contains no halide or halide-containing groups.

The polymers resulting from such reactions can be represented by Formula (6):

$$HS - {M}^{5} - {( {S}_{c} - {M}^{5} - )}_{n} - SH \qquad ( 6 )$$

c represents the number of sulfur atoms in each polysulfide chain. In embodiments, each c is in the range of from 2 to 10, for example from 2 to 5. In embodiments, all values of c are the same.

n is typically in the range of from 1 to 500, for example from 1 to 200 or from 2 to 100, such as in the range of from 2 to 50.

M⁵ is —([CR^{a}₂]_{d}E-)ₑ[CR^{a}₂]_{f} where R^{a} is selected from H, halide (typically selected from F or Cl), —ORD, C₁₋₄ alkyl (e.g. C₁₋₂ alkyl) and C₁₋₄ haloalkyl (e.g. C₁₋₂ haloalkyl). R^{b} is selected from H, C₁₋₄ alkyl and C₁₋₄ haloalkyl. E is as defined above. d is in the range of from 1 to 10 (for example from 1 to 4). e is in the range of from 0 to 20, for example from 0 to 10 or from 0 to 4. f is an integer in the range of from 1 to 20, for example from 2 to 10 or from 2 to 5. In embodiments, M⁵ contains no halide or halide-containing groups.

Examples of polysulfides are those which can be obtained by the polycondensation of bis-(2-chloroethoxy) methane with an alkali sulfide such as L₂S_{c} (where L is an alkali metal such as sodium or potassium), where c is as defined above, although is typically in the range of from 2 to 5. The polysulfide resulting from this reaction can be represented by Formula (7):

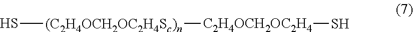

c and n are as defined above.

In embodiments, the number average molecular weight (Mₙ) of the polysulfide is at least 500, for example from 500 to 10000, for example from 700 to 8000. In embodiments, the polysulfide is liquid at room temperature (25° C.).

In embodiments, branches can be introduced into the polymer chains by conducting the synthesis in the presence of a haloalkyl compound such as a haloalkyl having from 3 to 10 carbon atoms and at least three halides, the halides typically being selected from Cl and Br. As an example, 1,2,3-trichloropropane can be added to the synthesis mixture to create branched moieties such as those of Formula (8):

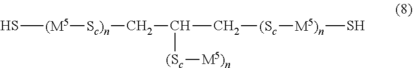

In such molecules, more than one trichloropropane group can be incorporated into the structure, to create additional branching points.

In embodiments, the composition can comprise a mixture of two or more different polysulfides.

Suitable polysulfides include Thioplast™ G (Nouryon), and Thiokol™ LP2 and LP3-type products (Morton Thiokol).

The total amount of polysulfide is typically in the range of from 10 to 35.0 wt %, for example from 10.0 to 30.0 wt. %, or from 12.0 to 25.0 wt. %.

### Carbonifics

The composition comprises at least one carbonific, which is an organic compound that contributes to char formation in the event of a fire. The char forms a hard coating layer on the substrate, which contributes to the insulating effect. The increased hardness of the char also helps to improve coating integrity in the often highly turbulent environment associated with fires.

Examples of additional carbonifics (sometimes referred to as carbon sources) include di-, tri-, tetra-, oligo- and polyhydric alcohols, such as such as glycerol, pentaerythritol, dipentaerythritol, and saccharides (including mono, di, tri, oligo, and polysaccharides) such as starch and cellulose. A specific example is dipentaerythritol.

Additional examples include hydroxylated polymers such as polyvinyl alcohol, hydrocarbon resins, and chloroparaffins.

The total amount of carbonific in the composition is typically in the range of from 2 to 20 wt %, for example from 4 to 15 wt %.

### Spumifics

The composition can comprise one or more spumifics. They are sometimes alternatively referred to as blowing agents or spumific agents.

They are able to release a non-flammable gas (such as nitrogen or carbon dioxide) when exposed to heat or flame which causes, or at least contributes to, foaming and expansion of the coating layer.

Examples of spumifics include urea and its derivatives, melamine and its derivatives, melem (1,3,4,6,7,9,9b-Heptaazaphenalene-2,5,8-triamine) and its derivatives, guanidine and its derivatives, 1,3,5-triazine-2,4,6-trione and its derivatives, and expandable graphite.

Derivatives of melamine, urea and guanidine include salts, e.g. borate salts, silicate salts, phosphate salts, pyrophosphate salts and cyanurate salts.

Other derivatives include substituted compounds where one or more hydrogen atoms in the molecule are substituted with one or more groups selected from hydroxy, cyano, C₁₋₆ alkyl, C₂₋₆ alkenyl, C₅₋₁₀ aryl, and C₅₋₁₀ aryl substituted with one or more aliphatic hydrocarbyl groups selected from C₁₋₆ alkyl and C₂₋₆ alkenyl. Any of the alkyl, alkenyl or aryl groups can optionally be substituted with one or more substituents selected from hydroxy, cyano, C₁₋₆ alkoxy, amino, C₁₋₆ alkylamine and C₁₋₆ dialkyl amino.

Further derivatives include dimeric, trimeric or oligomeric forms of the molecules, for example melam (2,2′-Iminobis(4,6-diamino-1,3,5-triazine)) as a dimeric form of melamine, and biurea as a dimeric form of urea.

Specific examples of urea derivatives include N-alkylureas such as methyl urea, N,N′-dialkylureas such as dimethylurea, N,N,N′-trialkyl ureas such as timethylurea, guanylurea, formamide amino urea, guanylurea phosphate, 1,3-diamino urea and biurea.

Specific examples of melamine derivatives include melamine cyanurate, melamine monophosphate, dimelamine phosphate, melamine biphosphate, melamine polyphosphate, melamine pyrophosphate and melam.

Example of guanidine derivatives include guanidine phosphate and dicyandiamide (1-cyanoguanidine).

An example of a 1,3,5-triazine-2,4,6-trione derivative is tris-(2-hydroxyethyl) isocyanurate (THEIC).

In embodiments, at least one of the spumifics is selected from melamine, melamine pyrophosphate and tris-(2-hydroxyethyl) isocyanurate (THEIC).

The total amount of spumific in the composition is typically in the range of from 5 to 30 wt %, for example from 7 to 30 wt % or from 10 to 20 wt %.

### Phosphoric Acid Source

The composition comprises one or more sources of phosphoric acid. In the event of fire, the phosphoric acid source produces an acid, which reacts with organic compounds in the composition (e.g. the epoxy binder and carbonifics) to form a char.

Typically, the sources of phosphoric acid are phosphoric acids themselves, and also salts of the acids. Examples of salts include ammonium, organoammonium (e.g. alkyl ammonium such as C₁₋₄ alkylammonium), alkali metal and alkaline earth metal salts. In embodiments, the sources of acids are inorganic sources (i.e. not comprising any carbon-containing groups), and in further embodiments are selected from alkali metal or ammonium salts.

Specific examples of sources of phosphoric acid include ammonium polyphosphate (APP), monoammonium phosphate, diammonium phosphate, potassium phosphate, potassium tripolyphosphate and sodium phosphate.

The total amount of phosphoric acid sources in the composition is in the range of from 10 to 50 wt %, for example from 15 to 35 wt %.

### Additional Sources of Acid

In addition to sources of phosphoric acid, other acid sources can optionally also be present. These include sources of boric acid, sulfuric acid, sulfonic acid, and sulfamic acid. The sources of such acids can be the acids themselves, and also salts as described above for phosphoric acids.

In embodiments, one or more sources of sulphuric acid can be present, which in further embodiments are selected from para-toluene sulfonic acid, ammonium sulphate, potassium sulphate and sodium sulphate.

Where additional sources of acid are used, they typically constitute no more than 15 wt % of the coating composition, for example no more than 10 wt % of the composition, or no more than 5 wt % of the composition.

In embodiments, the coating composition is free of any borate-containing compounds, i.e. it is free of boric acids and their inorganic and organic salts (e.g. ammonium borate, zinc borate, and borate salts of melamine, urea and guanidine).

### Functional Polysiloxane

The composition can comprise one or more functional polysiloxanes, which are curable and which have one or more moieties of formula —Si(R^{c})₃₋ₕ(OR^{c})ₕ. These moieties can be at pendant or terminal positions of the functional polysiloxane, or at both pendant and terminal positions. Such moieties can react with each other to form larger polysiloxane molecules, or they can react with functional groups on other components in the composition such as other reactive binder components.

Each R^{c} is independently selected from H and R^{d}.

Each R^{d} is independently selected from C₁₋₁₂ aliphatic hydrocarbyl group, C₆₋₁₂ aryl, and C₆₋₁₂ aryl optionally substituted with one or more (for example from 1 to 4) C₁₋₆ aliphatic hydrocarbyl groups. Each aliphatic hydrocarbyl group, aliphatic hydrocarbyl substituent and aryl group can optionally be substituted, as detailed further below.

h is an integer in the range of from 1 to 3.

In embodiments, the silane moiety is of formula —Si(R^{d})₃₋ₕ(OR^{c})ₕ.

In embodiments, each R^{d} is selected from optionally substituted C₁₋₆ aliphatic hydrocarbyl, optionally substituted phenyl and optionally substituted phenyl having one or more C₁₋₆ aliphatic hydrocarbyl groups.

In embodiments, the silane moiety is —Si(R^{d})₃₋ₕ(OR^{e})ₕ, where each R^{e} is independently selected from H, C₁₋₆ alkyl, phenyl and phenyl substituted with one or more C₁₋₆ alkyl groups, where the alkyl groups, alkyl substituents and phenyl groups are optionally substituted.

In further embodiments each Rd and each Re are selected from C₁₋₄ alkyl, and b is 2 or 3.

Each optional substituent in the R^{c}, R^{d} and R^{e} groups is independently selected from hydroxy, halide, C₁₋₆ alkoxy and C₁₋₆ haloalkoxy. In embodiments, there can be from 1 to 3 optional substituents on each group. In further embodiments, each group comprises from 1 to 2 optional substituents, for example no more than 1 optional substituent. In embodiments, there are no halide or halide-containing substituents, and in further embodiments the groups are unsubstituted.

In embodiments, the functional polysiloxane can be represented by Formula (9):

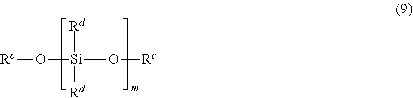

In such molecules, the —Si(R^{d})₃₋ₕ(OR^{c})ₕ moiety is on a terminal group of the molecule.

m is a number in the range of from 4 to 100.

In embodiments, each of R^{c} and R^{d} can be selected from aliphatic hydrocarbyl and phenyl, each of which can optionally be substituted as set out above.

In further embodiments, the functional polysiloxane is represented by Formula (10):

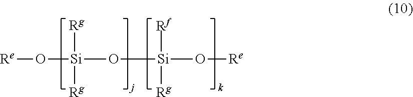

Each R^{f} is independently selected from C₆₋₁₀ aryl, C₆₋₂₀ aliphatic hydrocarbyl and C₆₋₁₀ aryl optionally substituted with one or more (for example from 1 to 4) C₁₋₆ aliphatic hydrocarbyl groups. Any aliphatic hydrocarbyl group and substituent, and any aryl group can optionally be substituted as set out above.

Each R^{g} can be an R^{e} group, although in embodiments no R^{g} can be H, such that each R^{g} is independently selected from C₁₋₆ alkyl, phenyl and phenyl substituted with one or more C₁₋₆ alkyl groups, where the alkyl groups, alkyl substituents and phenyl groups are optionally substituted as set out above for R^{c}, R^{d} and R^{e}.

j is a number in the range of from 1 to 100.

k is a number in the range of from 0 to 99.

The sum of j+k is in the range of from 4 to 100. In embodiments, the ratio of k/j is no more than 1, for example in the range of from 0.01 to 1.00, such as from 0.05 to 0.50, or from 0.08 to 0.30.

R^{f} is different from all R^{e} and R^{g} groups. In embodiments, in Formula (10), all occurrences of R^{e} and R^{g} have fewer carbon atoms than R^{f}. In embodiments, all occurrences of R^{e} and R^{g} are the same. In embodiments, each R^{e} and R^{g} is selected from optionally substituted C₁₋₂ alkyl and R^{f} is selected from optionally substituted C₄₋₁₀ alkyl and optionally substituted phenyl.

In embodiments, in Formulae (9) and/or (10), a or the sum of j+k can be in the range of from 10 to 80. For the functional polysiloxane as a whole, the average value for m (or for j+k) is in the range of from 5 to 100, for example from 10 to 80.

In embodiments, in Formulae (9) and/or (10), there are no halide or halide-containing substituents. In further embodiments all R^{c}, R^{d}, R^{e} R^{f} and R^{g} groups are unsubstituted.

In embodiments, the optionally substituted C₆₋₁₂ aryl or C₆₋₁₀ aryl group in R^{d} or R^{f} is an optionally substituted phenyl group.

In embodiments, the functional polysiloxane has a weight average molecular weight (Mw) in the range of from 500 to 5000, for example from 700 to 3000, such as from 1000 to 2000.

In embodiments, the functional polysiloxane has a viscosity in the range of from 30 to 500 cP, for example from 50 to 400 cP, such as from 70 to 250 cP (at 25° C.).

The content of functional polysiloxane in the coating composition, in embodiments, is no more than 20 wt % or no more than 10 wt %, for example in the range of from 0.1 to 20 wt %, such as from 0.5 to 10 wt %.

In two-component (2K) compositions, the functional polysiloxane can be included in either part (e.g. in the binder component (A) or the curing agent component(B)). In embodiments, it forms part of the binder component.

The amount of functional polysiloxane in the composition as a whole can be up to 20 wt %, for example up to 15 wt % or up to 10 wt %, for example being in the range of from 0.1 to 20 wt %, such as from 0.5 to 15 wt %, or from 1 to 10 wt %.

### Additional Curing Agents

In addition to the polysulfide, the composition can comprise additional curing agents. Such curing agents can be selected from amine- or amide-based curing agents, such as polyamides, polyamines, epoxy-amine adducts, phenalkamines, or phenalkamides.

Examples include amines or amino functional polymers selected from aliphatic (including cycloaliphatic) amines and polyamines, amido amines, polyamido amines, polyoxy alkylene amines (e.g. polyoxyalkylene diamines), aminated polyalkoxy ethers (e.g. those sold commercially as “Jeffamines”), alkylene amines (e.g. alkylene diamines), aromatic amines (including aralkyl amines), Mannich bases (e.g. those sold commercially as “phenalkamines”), amino functional silicones or silanes, and any epoxy adducts and derivatives thereof.

Additional examples include those listed in WO2018/046702 at page 21, line 10 to page 23, line 10. Further examples include those listed at page 10, line 23 to page 12, line 5 of WO2017/068015. Specific examples include ethylene diamine, hydroxyethyl ethylene diamine, diethylene triamine, triethylene tetramine, tetraethylene pentaamine, the reaction products with fatty acids or dimer fatty acids, to form amidoamines and amine functional polyamides (c.f. “Protective Coatings, Fundamentals of Chemistry and Composition” by Clive H. Hare, published by the Society for Protective Coatings, ISBN 0-938477-90-0). Additional examples include dicyandiamide, isophorone diamine, m-xylylene diamine, m-phenylene diamine, 1,3-bis(aminoethyl)cyclohexane, bis(4-aminocyclohexyl) methane, bis(4-amino-3-methycyclohexyl) methane, N-aminoethyl piperazine, 4,4′-diaminediphenyl methane, 4,4′-diamino-3,3′-diethyl diphenyl methane, diaminodiphenyl sulfone, and Mannich base curing agents manufactured using the above polyamine curing agents.

Adducts of any of these amines can also be used. Such adducts can be prepared by reaction of the amine with a suitably reactive compound such as a silicon-free epoxy resin or an epoxy functional reactive diluent, for example butyl glycidyl ether. Further examples of epoxy-functional reactive diluents are described in “Protective Coatings, Fundamentals of Chemistry and Composition”, by Clive H. Hare, published by the Society for Protective Coatings (ISBN 0-938477-90-0). Adducts of any of these amines can also be prepared by reaction of the amine with a suitably reactive compound such as an acrylate, a maleate, a fumarate, a methacrylate, or even electrophilic vinyl compounds such as acrylonitrile.

The composition can comprise more than one additional curing agent, e.g. blends of two or more of any of the above curing agents.

In embodiments, the viscosity of the additional curing agent(s) is below 300 cP, for example 100 to 300 cP.

If used, the concentration of any additional curing agents in the coating composition is typically no more than 15 wt % or no more than 10 wt %. In embodiments, the total amount of curing agent used (i.e. polysulfides plus additional curing agents) is in the range of from 10 to 35.0 wt %, for example from 10.0 to 30.0 wt. %, or from 12.0 to 25.0 wt %.

### Catalysts

The polysulfide (or additional curing agents) can be used in combination with a cross-linking catalyst (often also called a curing accelerator, an activator, or a catalyst). These can be selected from tertiary amines and phenols.

Specific examples include trimethylamine, ethyldimethylamine, propyldimethylamine, N,N′-dimethylpiperazine, pyridine, picoline, 1,8-diazabicyclo(5.4.0)undecane-1 (DBU), benzyldimethylamine, 2-(dimethylaminomethyl) phenol (DMP-10), 2,4,6-tris(dimethylaminoethyl) phenol (DMP-30), phenol novolac, o-cresol novolac, p-cresol novolac, t-butylphenol novolac, and dicyclopentadiene cresol. Further examples of catalysts include p-toluenesulfonic acid and amino-aliphatic heterocyclic salts of thiocyanic acids, e.g. the 1-aminopyrrolidone salt of thiocyanic acid (as described, for example, in U.S. Pat. No. 6,503,967).

The amount of catalyst used is typically no more than 10.0 wt %, for example no more than 5.0 wt. %. In embodiments, the amount used is in the range of from 0.1 to 10.0 wt %, for example from 0.1 to 5 wt %.

### Other Resins

The coating composition can optionally comprise one or more additional curable resins. In embodiments, the total amount of other curable resins in the coating composition as a whole is no more than 15 wt %, for example 10 wt % or less.

Such resins include acrylate-based resins, saturated or unsaturated polyester resins, polyether resins, alkyd resins, polycarbonate resins, amino resins, phenolic resins, ketone and aldehyde resins, polyamide resins, polyisocyanate resins, polyurethane resins, silicone resins, and rubber-based resins.

In embodiments, there are no additional curable resins.

### Reactive Modifiers/Diluents

The composition can comprise one or more reactive modifiers or diluents, which have functional groups that can chemically react with other components of the composition, but which are not considered resins, in that they would not form a suitable coating film in their own right.

They typically have only one epoxy moiety, for example those of Formulae (11) and (12);

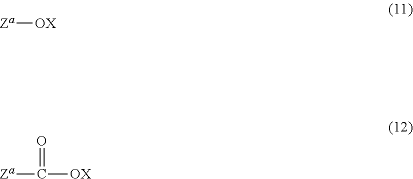

X is as defined above. c is an integer in the range of from 1 to 3, and in embodiments is 1.

Z^{a} is selected from Z and Ar, as defined above.

Examples of such reactive modifiers or diluents include phenyl glycidyl ether, C₁₋₃₀ alkyl phenyl glycidyl ethers (e.g. C₁₋₁₂ or C₁₋₅ alkyl phenyl glycidyl ethers such as methyl phenyl glycidyl ether, ethyl phenyl glycidyl ether, propyl phenyl glycidyl ether and para t-butyl phenyl glycidyl ether), and glycidyl esters of carboxylic acids (e.g. glycidyl esters of fatty acids or versatic acids such as pivalic acid or neodecanoic acid).

### Cross-Linking Agents

The composition optionally comprises one or more crosslinking agents that can facilitate crosslinking of the reactive components of the composition, e.g. the epoxy resin and any other resins or functional polysiloxanes.

The cross-linking agent, in embodiments, can be selected from those of formula Si(R^{k})_{4-z}(OR^{h})_{z}, where z is an integer in the range of from 1 to 4, for example from 1 to 3 or from 1 to 2.

R^{h} is independently selected from C₁₋₁₂ aliphatic hydrocarbyl, C₆₋₁₂ aryl, and C₆₋₁₂ aryl substituted with one or more (for example from 1 to 4) C₁₋₆ aliphatic hydrocarbyl groups

Each R^{k} is independently selected from C₁₋₁₂ aliphatic hydrocarbyl, C₆₋₁₂ aryl, and C₆₋₁₂ aryl substituted with one or more (for example from 1 to 4) C₁₋₆ aliphatic hydrocarbyl groups, wherein each aliphatic hydrocarbyl group, aliphatic hydrocarbyl substituent and aryl group can optionally be substituted with one or more groups selected from halide, —OR^{j}, —NR^{j}₂, and —SR^{j}, where R^{j} is selected from H, C₁₋₆ alkyl and C₁₋₆ haloalkyl. Halides in the halide and haloalkyl substituents are typically selected from F and Cl.

In embodiments, all R^{k} groups are selected from H and optionally substituted C₁₋₆ alkyl. In embodiments, each R^{j} is independently selected from H and C₁₋₄ alkyl.

In embodiments, no crosslinking agent comprises halide or halide-containing groups or substituents.

In embodiments, the crosslinking agent can be of formula Si(OR^{h})₄, and each R^{h} is selected from H and C₁₋₄ alkyl.

In embodiments z is 3 or less, and at least one R^{k} group comprises a substituent. In embodiments, at least one R^{k} group comprises an —SR^{j} substutyted C₁₋₆ alkyl group, for example an —SH substituted C₁₋₆ alkyl group. In embodiments, the (or at least one) R^{k} group is an —SR^{j} substituted propyl group, such as a mercaptopropyl group.

Examples of cross-linking agents include gamma-aminosilane (or N-[3-(trimethoxysilyl)propyl]ethylenediamine), alpha-aminosilane (or N,N-(diethylaminomethyl)triethoxysilane), glycidyloxypropyl triethoxysilane, glycidyloxypropyl trimethoxysilane, tetraethoxysilane (TEOS) and 3-mercaptopropyl trimethoxysilane (MTMO).

In embodiments, the total content of the crosslinking agent(s) in the coating composition is up to 5.0 wt %, for example up to 3.0 wt % or up to 1.5 wt %. In embodiments, the content of cross-linking agent in the coating composition is in the range of from 0.1 to 5.0 wt %, for example in the range of from 0.2 to 3.0 wt %, or 0.3 to 1.5 wt %.

### Fibres

Fibres can be included in the coating composition, which can enhance the stability and/or strength of the char. The fibres are generally inert to the various reactions that take place during the curing/drying of the composition and during high heat or fire exposure of the composition.

Suitable fibres include glass fibres, mineral fibres, and high temperature resistant man-made fibres, such as carbon fibres and p-aramid and m-aramid fibres.

In embodiments, the composition can comprise up to 15 wt % fibres. In embodiments, the coating composition comprises at least 0.01 wt % of fibres, for example from 0.01 to 15 wt % fibres. In further embodiments, the composition can comprise at least 0.05 wt. % of fibres, for example in the range of from 0.05 to 15 wt % fibres or from 1 to 15 wt % fibres, such as from 5 to 15 wt % fibres.

### Solids/Solvent Content

The composition can comprise an organic solvent or it can be solvent-free. In embodiments, there are one or more organic solvents selected from organic liquids that have a boiling point of 250° C. or lower at atmospheric pressure (i.e. 101.3 kPa). Once the coating composition is dried or cured, the organic solvent is, essentially, no longer present in the composition, or at least not above impurity levels of, for example, 1000 ppm or less.

Examples of organic solvents include alkyl aromatic hydrocarbons (such as xylene, toluene and trimethyl benzene), aliphatic hydrocarbons (such as cyclic and acyclic hydrocarbons selected from C₄₋₂₀ alkanes, or mixtures of any two or more thereof), alcohols (such as benzyl alcohol, octyl phenol, resorcinol, n-butanol, isobutanol and isopropanol), ethers (such as methoxypropanol), ketones (such as methyl ethyl ketone, methyl isobutyl ketone and methyl isopentyl ketone), and esters (such as butyl acetate). In embodiments, the organic solvent comprises from 2 to 20 carbon atoms, for example from 3 to 15 carbon atoms. Mixtures of any two or more organic solvents can be used.

When organic solvent is used, its amount in total can constitute up to 50 wt % of the total weight of the coating composition, although in embodiments it comprises 25 wt % or less. In preferred embodiments, the organic solvent concentration is no more than 10 wt %. In further embodiments, it is no more than 5 wt % for example no more than 1 wt %. In further embodiments, it is solvent-free.

By “solvent-free” is meant no added organic solvent. However, there may be small amounts present in the component materials of the coating composition (e.g. organic solvent may be present in small quantities). Typically, where a coating composition is said to be “solvent-free”, the total amount of solvent is less than 1000 ppm, for example less than 500 ppm in the coating composition.

The organic solvent content is separate to the water content. The coating composition is typically a non-aqueous composition. Although water can be present, it is typically at a low concentration. If present, it is typically at concentrations of 5 wt % or less, for example 1 wt % or less, such as 0.5 wt % or less, based on the coating composition as a whole.

Components that are not solvents are often termed “solids”. This does not necessarily mean that the component is actually a solid, but instead refers to non-volatile components that are assumed to remain in and form part of the coating layer once dried and cured. Thus, the volatile components (solvents) evaporate, and the materials that remain are referred to as the coatings solids. The solids would include, for example, liquid materials such as plasticisers, reactive diluents, etc. that are not volatile and are expected to be retained in the dried film.

The solids volume, weight of solids and the solvent content can be calculated using method ASTM D5201-05a.

### Additional Components

The coating composition may optionally contain other components, for example one or more substances selected from anti-corrosion additives, pigments, fire-retardants, gloss additives, waxes, rosins, fillers and extenders, thickening agents, thixotropic agents, plasticizers, inorganic and organic dehydrators (stabilizers), UV stabilizers, defoamers, non-volatile and non-reactive fluids, chain transfer agents and any combination thereof. These components are well-known to the skilled person.

The total amount of such further optional components can be in the range of from 0 to 65 wt % based on the total content of the coating composition.

In embodiments, the coating composition is an intumescent coating composition, i.e. one that swells and chars to form a hard, insulating layer on the surface of the substrate. Such compositions can comprise one or more acid sources, spumifics and, in embodiments, additional sources of carbon.

### Preparation of the Coating Composition

The coating composition is typically prepared by mixing the various ingredients together, for example using a mechanical mixer such as a high-speed disperser, a ball mill, a pearl mill, a three-roll mill or an inline mixer.

The compositions may be filtered, for example using bag filters, patron filters, wire gap filters, wedge wire filters, metal edge filters, EGLM tumoclean filters (ex Cuno), DELTA strain filters (ex Cuno), and Jenag Strainer filters (ex Jenag), or by vibration filtration.

The compositions can be provided in the form of a pack or kit in which the epoxy resin is part of a binder component, and the polysulfide is part of a curing component. An example is a 2K (2-component) coating composition, where the binder component is often referred to as Part A, and the curing component Part B.

The separate components (e.g. the Part A and Part B components of a 2K composition) can be prepared and provided separately, and the two separate components can then be mixed together shortly before application to the substrate.

In an embodiment, the epoxy resin-containing component (part A) and the curing agent component (part B) can be mixed and stirred until homogeneous before application. In alternative embodiments, they can be fed separately directly to application equipment, e.g. airless or air spraying equipment. The combined mixture can then be applied to a substrate, optionally after a prior induction time.

### Application of the Coating Composition

The coating composition can be applied to a substrate (for example a steel structure) by known methods, for example by conventional air-spraying, by airless- or airmix-spraying equipment, or by 2K airless spray pumps. It can alternatively be applied using brush or roller. The composition can be applied at ambient conditions without pre-heating the coating composition. In spraying applications, conventional pressures such as in the range of from 2 to 5 bar (gauge) can be used.

The coating composition is typically curable at ambient temperature, for example at a temperature in the range of from −10 to 50° C., for example in the range of from 0 to 40° C.

The coating composition is typically self-curing, i.e. is able to self-cure once the curing and binder components are mixed, without the need for any additional initiation process, e.g. heat or UV radiation. Heat can optionally be applied should the rate of curing need to be accelerated.

The composition can be applied as a single coat, although if desired multiple coats can be applied. Supporting meshes can be used, although this is not necessary. Thus, the coating compositions can maintain their integrity both before and after curing without the need for a supporting mesh. This reduces the complexity of the coating application process.

The binder and curing components can be kept separate before use, to avoid premature curing of the binder, i.e. they can be supplied as a so-called 2-K (2 component) composition. Therefore, in embodiments, the coating composition comprises two separate parts, i.e. a first part (A) comprising the binder, and a second part (B) comprising the curing agent. When used, the two parts (A) and (B) are mixed together to form the coating composition and applied to a substrate. The composition then cures to form a film or layer on the substrate surface.

In such embodiments, the mixing ratio of the first and second parts of the composition is at least in part determined by the respective amounts of epoxy and active hydrogens present in the total composition.

The coating can be applied to give a total dry film thickness of from 0.5 to 20.0 mm, such as from 1.0 to 18 mm or from 3 to 15 mm.

The coating composition can be used on its own, or can be applied on top of underlying coatings, for example primer or corrosion prevention coatings. Additionally or alternatively, one or more coating layers can be applied on top of the heat resistant coating composition, e.g. a decorative paint.

The coating composition can be applied to any surface, although it is particularly suitable for protecting metal substrates, for example steel or aluminium. In embodiments, the substrate is metallic structure associated with a building, a ship, a drilling rig, a storage depot, or a manufacturing plant such as a chemical plant or oil refinery.

The coating composition can be coated onto a pre-treated substrate, for example on top of a previously applied coating layer such as a primer layer or a tie coat.

The coating composition forms a polymeric film or layer on the substrate. The layer can optionally be overcoated with other coating layers, for example using one or more coatings selected from coloured decorative coatings, UV protective coatings, water resistant coatings, antifouling coatings and antimould coatings.

### Component Ratios

In the coating compositions, the mole ratio of thiol groups in the one or more polysulfides to epoxy groups in the one or more epoxy resins is maintained in the range of from 0.20 to 0.50. In embodiments, the lower limit of this range can be 0.24 or 0.25. In further embodiments, the upper limit of this range can be 0.45.

It has been found that maintaining this ratio in the range of from 0.20 to 0.35 (e.g. 0.24 to 0.35 or 0.25 to 0.35) leads to good performance in jet fire tests, whereas the range >0.35 to 0.50 (e.g. >0.35 to 0.45) leads to good performance in pool fire tests. This is achieved while maintaining effective performance in the other type of test, although allows the overall performance to be tailored.

The weight ratios of the total amount of carbonific components to the total amount of spumific components in the composition is 0.48 or less, typically 0.45 or less or in embodiments 0.40 or less. In addition, the ratio can be from 0.15 or more, for example in the range of from 0.15 to 0.48 or from 0.20 to 0.45 such as from 0.25 to 0.40.

Additionally or alternatively, the weight ratio of the total amount of carbonific components to the total amount of sources of phosphoric acid is 0.38 or less, and typically 0.36 or less, for example 0.32 or less, such as 0.30 or less. The ratio can also be 0.10 or more, for example 0.15 or more for example 0.20 or more. Thus, in embodiments, the ratio is maintained in the range of from 0.10 to 0.38, from 0.10 to 0.36, from 0.15 to 0.32, or from 0.20 to 0.30.

Maintaining the carbonific:spumific and/or carbonific:phosphoric acid ratios within these ranges helps to improve performance in jet-fire tests and pool fire tests compared to compositions having higher values.

### EXAMPLES

The invention will now be described with reference to the following, non-limiting examples.

### Components

The following materials were used in preparing the samples.

### Epoxy Resins

(a) DER™ 331 from Dow Chemical—an epoxy resin that is liquid at room temperature. It is the reaction product of epichlorohydrin and bisphenol A.
(b) DER™ 736 from Dow Chemical—an epoxy resin that is liquid at room temperature. It is the reaction product of epichlorohydrin and dipropylene glycol.

### Functional Polysiloxane

Dowsil™ 3074 from Dow Corning—a methoxy functional phenyl methyl polysiloxane resin, with a phenyl:methyl ratio of 1.0:1.

### Polysulfide

(a) Thioplast™ G4—a polysulfide end-capped by —SH groups, and having a —SH content of 6.0-7.0% and an average molecular weight of <1100 g/mol. It is liquid at room temperature. It is formed from polycondensation of bis-(2-chloro-ethyl)-formal with alkali polysulfide.
(b) Thiokol™ LP3—a liquid diethoxymethane polysulfide polymer end capped with —SH groups, with a formula H(S—C₂H₄OCH₂OC₂H₄S)ₙH, with a mercaptan content of content of 5.9-7.7% and an average molecular weight of 1000.

### Carbonific

Charmor™ DP40 from Perstorp—Dipentaerythritol

### Source of Phosphoric Acid

Exolit™ AP422 from Clariant—ammonium polyphosphate.

### Spumific

Melafine™ Grade 003 from OCI—Melamine.

### Catalyst

Ancamine™ K54 from Evonik—tris-(dimethylaminomethyl)phenol

### Cross-Linking Agent

Dynasylan™ MTMO from Evonik—3-mercaptopropyltrimethoxysilane

### Fibres

(a) FG400/030 from Schwarzwalder Textile Werke—Glass fibres
(b) Sigrafil™ C30 M150 UN—Carbon fibres
(c) Sigrafil™ C3-4—Carbon fibres
(d) Roxul™ MS675—Mineral fibres

### Others

(a) Thickener—Cabosil™ TS720 from Cabot Corp.
(b) Platicizer—Phosflex™ 71B from ICL industrial.
(c) Pigment—Kronos 2190—Titanium dioxide (rutile)

### Examples 1 to 5 and Comparative Examples 1 to 2

Compositions were made according to the recipes set out in Table 1.

TABLE 1
Formulations for the Examples

| | Content in total composition (wt parts) | | | | | | |
|---|---|---|---|---|---|---|---|
| | | | | | | C. | C. |
| Material | Ex. 1 | Ex. 2 | Ex. 3 | Ex. 4 | Ex. 5 | Ex. 1 | Ex. 2 |
| Binder Component | | | | | | | |
| Epoxy (a)+(b) | 20.2 | 16.4 | 16.1 | 17.1 | 14.2 | 16.9 | 21.3 |
| Polysiloxane | 1.0 | 5.0 | 5.0 | 1.0 | 5.0 | 0.6 | — |
| Phosphoric Acid | 24.5 | 23.5 | 23.4 | 23.5 | 23.4 | 19.4 | 20.3 |
| Source | | | | | | | |
| Spumific | 8.0 | 7.7 | 7.7 | 7.7 | 7.6 | 7.3 | 10.6 |
| Fibres (a) + (b) + (c) | 4.6 | 3.8 | 3.7 | 4.4 | 3.8 | 3.5 | 2.6 |
| Other (a) + (b) | 1.8 | 1.5 | 1.7 | 1.5 | 1.6 | 2.1 | 6.1 |
| TOTAL | 60.1 | 57.9 | 57.6 | 55.2 | 55.6 | 49.7 | 60.9 |
| Curing Component | | | | | | | |
| Polysulfide (a)/(b) [1] | 13.9 | 16.8 | 16.6 | 20.1 | 18.8 | 21.9 | 14.8 |
| Catalyst | 2.5 | 2.0 | 2.0 | 2.1 | 1.7 | 2.2 | 2.6 |
| Cross-Linking Agent | — | — | 0.5 | — | 0.5 | — | — |
| Spumific | 10.4 | 10.0 | 9.9 | 9.9 | 9.9 | 7.3 | 4.7 |
| Carbonific | 6.1 | 5.9 | 5.8 | 5.9 | 5.8 | 7.5 | 7.9 |
| Fibres (a) + (b) + | 2.0 | 2.5 | 2.5 | 1.9 | 2.5 | 5.1 | 3.1 |
| (c) + (d) | | | | | | | |
| Other (b) + (c) | 5.0 | 4.9 | 5.1 | 4.8 | 5.2 | 5.9 | 6.0 |
| TOTAL | 39.9 | 42.1 | 42.4 | 44.7 | 44.4 | 49.9 | 39.1 |
| HS:Epoxy Mole Ratio | 0.23 | 0.35 | 0.35 | 0.4 | 0.45 | 0.44 | 0.24 |
| Carbonific/ | 0.25 | 0.25 | 0.25 | 0.25 | 0.25 | 0.39 | 0.39 |
| PA Source (w/w) | | | | | | | |
| Carbonific/ | 0.33 | 0.33 | 0.33 | 0.34 | 0.33 | 0.51 | 0.51 |
| Spumific (w/w) | | | | | | | |

[1] Polysulfide (a) was used for Examples 1-5 and Comparative Example 1. Polysulfide (b) was used for Comparative Example 2

The constituent parts of the binder and curing components were separately mixed, and the two components kept separate until application. In each component, the liquid ingredients were first mixed together before adding the solid components. Fibres were added last. High speed dispersers were used for Experiments 1-4, and a large-scale high-speed dispersion dissolver (Turello™ TMD1300 machine fitted with a Turello™ hydro drum press out unit) was used for Experiments 5 and 6. Typical mixing times were about 75 mins to ensure uniformity.

### Experiment 1

Samples were heated in a cube furnace to simulate pool fire-type conditions. The composition was applied to 300×300×5 mm steel panels to give a dry film thickness (DFT) of 5 mm. Five thermocouples were attached to the steel panel—one centrally, and four at the corners, on the non-coated surface. The panels were then placed in the door frame of a 1.5 m cube furnace and subjected to a heating regime according to standard BS476 part 20. The calculated time-to-failure was based on the average time taken for the thermocouple readings to reach 538° C.

### Experiment 2

These were larger-scale tests compared to those of Experiment 1. These tests were conducted using a 2×3×2 m furnace (2 m high) using coated 1 m or 1.8 m high steel “I”-sections, with a coating dry film thickness (DFT) of 9 mm, and a section factor of 160 Hp/A.

UL thermocouples were arranged in three bands with 5 thermocouples in each band monitoring temperature on the toe edges and web. The columns were cured for a minimum of 2 weeks at ambient temps then subjected to a heating regime according to standard UL1709. The time-to-failure was taken as either the time for the mean band temperatures to reach 538° C., or for a single reading to reach 649° C.

Some examples used a mesh, located mid-way through the coating layer, and had lower dry film thicknesses of 6 mm.

The Hp/A section factor of a substrate is a measure of the heatable perimeter of a substrate's cross section (Hp) divided by the area of the cross-section (A). Because substrates with a larger Hp/A have more heatable surface per unit area (or volume), they generally need thicker coating layers to achieve fire protection performance equivalent to a substrate with lower Hp/A. Similarly, for two substrates having equal coating thicknesses, the substrate with the higher Hp/A section factor would be expected to have a faster time-to-failure than the substrate with a lower Hp/A section factor.

### Experiment 3

Samples were subjected to a vertical column furnace which was certified under the UL 1709 test standard. Coatings were applied to 2.4 m 160 Hp/A section factor I-columns at a dry film thickness of 9 mm. Thermocouples were arranged in four bands with 5 thermocouples per band. The time-to-failure was taken as either the time for the mean band temperatures to reach 538° C., or for a single reading on any section to reach 649° C.

### Experiment 4

The same procedure as Experiment 3 was used, except that a mesh was located at the mid-point of the coating. The dry film thickness was 9 mm.

### Experiment 5

Jet fire tests were conducted in accordance with test standard ISO 22899-1, using a carbon steel jet-fire box of 1.5 m dimensions, coated internally with the coating composition at a dry film thickness of 6 mm. The specimen used 18 thermocouples located on the back face of the box and central flange. The time-to-failure was measured as a 400° C. temperature increase for any of the thermocouples on the specimen.

### Experiment 6

A similar procedure to that used in Experiment 5 was employed, except that a mesh was situated mid-way through the coating layer.

### Results

Time to failure results in pool fire tests for the samples studied in Experiments 1 to 4 are shown in Table 2, with the results of the jet-fire tests of Experiments 5 and 6 shown in Table 3.

Comparative Example 1 required a mesh to ensure sufficient integrity in the jet fire test, and hence no result for this example is reported for Experiment 5.

The results demonstrate that improved performance in both jet fire and pool fire tests can be achieved by maintaining the relative mole ratio of reactive sulfur groups (e.g. thiol groups) on the polysulfide to the reactive epoxy groups on the binder resin at a value in the range of from 0.20 to 0.50. In addition, maintaining a carbonific to spumific weight ratio of no more than 0.48 and/or a carbonific to phosphoric acid source weight ratio of no more than 0.38 also achieves improvements over comparative compositions having higher ratios. They further demonstrate that the inventive compositions have improved integrity in jet-fire tests without the need for a supporting mesh.

TABLE 2
Time to Failure in Pool Fire Experiments (minutes)

| Experiment | Ex. 1 | Ex. 2 | Ex. 3 | Ex. 4 | Ex. 5 | C. Ex. 1 |
|---|---|---|---|---|---|---|
| 1 | 60 | 89 | | 80 | 102 | 84 |
| 2 | 72 | 111 | 126 | | 104 [1b][2] | 91 [1b][2] |
| 3 | | 108 | 130 | | 110 | |
| 4 | | | | | 162 [1a][3] | 125[1b] |

[1] Mesh used; (a) Charlok ™, (b) International HK1 ™
[2] 6 mm coating DFT
[3] 8 mm coating DFT

TABLE 3
Time to Failure in Jet Fire Experiments (minutes)

| Experiment | Ex. 1 | Ex. 2 | Ex. 3 | Ex. 4 | Ex. 5 | C. Ex. 1 | C. Ex. 2 |
|---|---|---|---|---|---|---|---|
| 5 | 47 | 48 | 82 | | 21 | — [5] | 4.5 |
| 6 | — | — | — | — | 52 [1b] | 53 [1b][4] | 21 [1a] |

[1] Mesh used; (a) International HK1TM; (b) International HK2 ™
[4] result for 6 mm coating DFT based on linear interpolation of separate results at 4 mm, and 12mm.
[5] a mesh was required to ensure sufficient stability during the jet fire test

1. A heat-resistant coating composition comprising one or more epoxy resins, one or more polysulfides, one or more spumifics, one or more carbonifics and one or more sources of phosphoric acid;
wherein the mole ratio of thiol groups in the polysulfide(s) to epoxy groups in the epoxy resin(s) is in the range of from 0.20 to 0.50;
and wherein the weight ratio of carbonific(s) to spumific(s) is no more than 0.48 or the weight ratio of carbonific(s) to source(s) of phosphoric acid is no more than 0.38, or both.

2. The heat-resistant coating composition as claimed in claim 1, in which one or more of the following apply:
(a) the weight ratio of carbonific(s) to spumific(s) is in the range of from 0.15 to 0.48;
(b) the weight ratio of carbonific(s) to sources of phosphoric acid is in the range of from 0.10 to 0.38;
(c) the solids content of the composition is at least 50wt %;
(d) the mole ratio of thiol groups in the polysulfide(s) to epoxy groups in the epoxy resin(s) is in a range selected from 0.24 to 0.50, 0.25 to 0.50, 0.20 to 0.45, 0.24 to 0.45 and 0.25 to 0.45.

3. The heat-resistant coating composition as claimed in claim 1, in which one or more of the following apply:
(a) at least one of the sources or all of the sources of phosphoric acid is selected from form phosphoric acids and ammonium, organoammonium, alkali metal and alkaline earth metal salts thereof;
(b) at least one of the spumifics or all of the spumifics are selected from urea and its derivatives, melamine and its derivatives, melem (1,3,4,6,7,9,9b-Heptaazaphenalene-2,5,8-triamine) and its derivatives, guanidine and its derivatives, 1,3,5-triazine-2,4,6-trione and its derivatives, and expandable graphite;
(c) at least one of the carbonifics or all of the carbonifics are selected from di-, tri-, tetra-, oligo- and polyhydric alcohols, such as such as glycerol, pentaerythritol, dipentaerythritol, saccharides, hydroxylated polymers, hydrocarbon resins, chloroparaffins, and phosphated plasticisers;
(d) the composition additionally comprises a functional polysiloxane;
(e) the composition additionally comprises an amide or amine-based curing agent;
(f) the composition additionally comprises a cross-linking agent;
(g) the composition additionally comprises fibres;
(h) the composition additionally comprises a catalyst.

4. The heat-resistant coating composition as claimed in claim 3, which additionally comprises a cross-linking agent selected from compounds of formula Si(R^{k})_{4-z}(OR^{h})_{z}, where;
z is an integer in the range of from 1 to 4;
each R^{h} is independently selected from C₁₋₁₂ aliphatic hydrocarbyl, C₆₋₁₂ aryl, and C₆₋₁₂ aryl substituted with one or more C₁₋₆ aliphatic hydrocarbyl groups;
each R^{k} is independently selected from C₁₋₁₂ aliphatic hydrocarbyl, C₆₋₁₂ aryl, and C₆₋₁₂ aryl substituted with one or more C₁₋₆ aliphatic hydrocarbyl groups, wherein in R^{k} each aliphatic hydrocarbyl group, aliphatic hydrocarbyl substituent and aryl group can optionally be substituted with one or more groups selected from halide, —OR^{j}, —NR^{j}₂, and —SR^{j}, wherein each R^{j} is independently selected from H, C₁₋₆ alkyl and C₁₋₆ haloalkyl.

5. The heat-resistant coating composition as claimed in claim 4, in which z is from 1 to 3, and at least one R^{k} group is selected from C₁₋₆ alkyl comprising an —SR^{j} substituent.

6. The heat-resistant coating composition as claimed in claim 1, in which one or more of the following apply:
(a) the total content of epoxy resins in the composition is in the range of from 5 to 55 wt %;
(b) the total content of polysulfide in the composition is in the range of from 10 to 35 wt %;
(c) the total content of spumific in the composition is in the range of from 5 to 30 wt %;
(d) the total amount of carbonific in the composition is in the range of from 2 to 20 wt %;
(e) the total amount of phosphoric acid sources in the composition is in the range of from 10 to 50 wt %;
(f) the composition additionally comprises a cross-linking agent in a total amount of no more than 5.0 wt %;
(g) the composition additionally comprises a catalyst in a total amount of no more than 10 wt %;
(h) the composition additionally comprises fibres in a total amount of 0.01 to 15 wt %;
(i) the composition additionally comprises functional polysiloxane in a total amount of 0.1 to 20 wt %;
(j) at least one or all sources of phosphoric acid are selected from phosphoric acid and inorganic salts thereof.

7. The heat-resistant coating composition as claimed in claim 1, in which there are no boric acids or borate-containing compounds.

8. The heat-resistant coating composition as claimed in claim 1, wherein the heat-resistant coating composition is an intumescent coating composition.

9. The heat-resistant coating composition as claimed in claim 1, wherein the heat-resistant coating composition is provided in 2-components comprising a part A and a part B, in which part A comprises at least one or all of the epoxy resins and part B comprises at least one or all of the polysulfides.

10. (canceled)

11. Use of a heat-resistant coating composition according to claim 1 for coating a substrate, wherein the heat-resistant coating composition is applied to a surface of the substrate and allowed to cure.

12. The use as claimed in claim 11, in which the curing takes place at a temperature in the range of from −10 to 50° C.

13. The use as claimed in claim 11, in which the substrate is a metal substrate.

14. A substrate coated with a heat-resistant coating composition as claimed in claim 1.

15. A substrate as claimed in claim 14, in which the heat-resistant coating composition is cured.
